(19) United States
(12) Patent Application Publication
(10) Pub. No.: US 2003/0046151 A1
(43) Pub. Date: Mar. 6, 2003

(54) Dynamic audio advertising updates

(76) Inventors: Joe S. Abuan, Fremont, CA (US); Berkat S. Tung, Sacramento, CA (US); Seung Ho Cho, Santa Clara, CA (US)

Correspondence Address: RONALD S. HENDERSON, ESQ., BARNES & THORNBURG, 11 SOUTH MERIDIAN STREET, INDIANAPOLIS, IN, 46204, US

(21) Appl. No.: 09/935,085

(22) Filed: Aug. 22, 2001

(51) Int. Cl. G06F 17/60

(52) U.S. Cl. 705/14

(57) ABSTRACT

A method for updating audio advertisement that a caller may hear while using an Internet telephone service. The updating of the audio ads can occur in a dynamic fashion for the effective targeting of consumers with an appropriate advertisement, promotional offer, and/or other marketing technique. The present invention allows custom audio ads to be played at the beginning and/or end of the Internet call. The audio ads may be played to the user as part of a predefined sequence, frequency, and/or rotation of audio ads.

### REFERENCE TO APPENDICES

Appendix A includes a listing of components of the client module for establishing an audio communication in accordance with an embodiment of the present invention. Appendix A is an integral part of the present disclosure, and is incorporated by reference herein in its entirety.

The computer program listing Appendix B attached hereto consists of two (2) identical compact disks, copy 1 and copy 2, each containing a listing of software code outlining an exemplary method for providing dynamically updated audio data in accordance with the present invention. Each compact disk contains the following files:

| Date | Time | Bytes | Filename |
|---|---|---|---|
| Jun. 06, 2001 | 06:00p | 10,505 | AUDIOA˜1.CPP |
| Jun. 06, 2001 | 06:00p | 4,555 | AUDIOA˜1.H |
| Jun. 06, 2001 | 06:00p | 14,731 | CACHEDB.CPP |
| Jun. 06, 2001 | 06:00p | 3,567 | CACHEDB.H |

The contents of the compact disk are a part of the present disclosure, and are incorporated by reference herein in their entireties.

Appendices A and B contain copyrighted material. The copyright owner, Dialpad Communications, Inc., has no objection to the facsimile reproduction by anyone of the patent documents or patent disclosure, as it appears in the Patent and Trademark Office patent files or records, but otherwise reserves all copyrights whatsoever.

### BACKGROUND

1. Field of the Invention

The present invention generally relates to audio communications; and more particularly to a method for dynamically updating audio files during an audio communication.

2. Discussion of Related Art

Voice over Internet Protocol (VoIP) technology has made possible many Internet communication related services. The VoIP technology is based on the ITU-T H.323 standard and supports audio, video, data, or fax communications using the Internet Protocol (IP) on the public Internet and within private Intranets.

Of interest to the present invention, VoIP makes available Internet telephone service, which allows a caller to place a telephone call from his/her personal computer (PC) through the Internet to another audio communication device, such as another PC or a wired or wireless telephone. Internet telephone service can take many forms. Typically, a caller accesses an Internet telephone service provider's web site, which provides an interface to the Internet telephone service. The caller enters a telephone number and the telephone service “dials” the telephone number and “rings” the destination communication device (e.g., a telephone).

The advent and progress of Internet telephone services has provided yet another way in which goods and services can be marketed to consumers. Most recent forms of Internet marketing have included advertising that can be made to appear on a web page in an attempt to attract a potential consumer's attention to consider a particular product or service. Typically, advertisers use flashy banners and/or animated advertisements to increase the probability that a consumer will look away from the primary content of the web page and view the advertisement. Recently to improve the effectiveness of Internet advertising, advertisers are including an audio advertising to their marketing strategies. The audio advertising strategy is especially effective with Internet telephone services, since such services are closely interrelated to audio-based services.

However, improvements are needed over existing Internet audio advertising methods to make the methods more robust. In particular, it is desirable to provide features that allow audio advertisements to be dynamically updated without burdening the user or the system by requiring frequent downloads.

### SUMMARY

The present invention is a system and method for controlling access to a computer resource at an operation or method level.

The present invention provides a system and method for updating audio advertisement (hereinafter “audio ads) that a caller may hear while using an Internet telephone service. The updating of the audio ads can occur in a dynamic fashion for the effective targeting of consumers with an appropriate advertisement, promotional offer, and/or other marketing technique. Beneficially, the present invention allows custom audio ads to be played at the beginning and/or end of the Internet call. In accordance with features of the present invention, the audio ads may be played to the user as part of a predefined sequence, frequency, and/or rotation of audio ads. Advantageously, the audio ads may also be targeted to a particular user based on consumer profiles, which can include general demographics, such as age, sex, income level, and zip code, and the likes and interests of the consumer. In addition, the audio ads may be further linked to associated banner advertisements in order to provide more intense advertising targeting. It is believed that targeting advertisements to individual users based on the profiles and/or in association with visual advertisements maximizes the effectiveness of the marketing effort.

In one aspect of the present invention, a method is provided for providing dynamically updated audio data. The method includes downloading at least one multimedia module including audio advertisement data; retrieving configuration instructions; and broadcasting the audio advertisement data in accordance with the configuration instructions.

In another aspect of the present invention, a method is provided for providing audio advertisements for a user of a communication system, where the user accesses a web site, where a first audio advertisement can be provided to the user. The user can establish a path for audio communications.

In another aspect of the invention, a method is provided for advertising to users of a communications system, which provides communications between a caller and destination audio receiver. The method includes accessing a web page using a browser; retrieving audio advertisement processing information; and downloading a front audio ad module and a bumper audio ad module. The front audio advertisement is played as the caller establishes a communication link. The bumper audio advertisement is played after the caller terminates the communication link.

In another aspect of the invention, a system is provided for dynamically providing advertising to users of a telephony service. The system includes a communications module for providing communications between a caller and destination audio receiver; and an audio advertisement module providing audio advertisement processing information, a first audio advertisement and a second audio advertisement. The first audio advertisement and the second audio advertisement can be played to the caller according to the processing information.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 schematically depicts a communication system used to provide communications between any caller and any destination audio communication device;

FIG. 2 schematically depicts a communication system used to provide communications between any caller and any destination audio communication device and provide audio advertisements;

FIG. 3A is an exemplary web page;

FIG. 3B schematically depicts a representative Internet telephone service applet, which can be used to create a communication;

FIG. 4 is a flow diagram of an exemplary processes of an audio advertising module in accordance with the present invention;

FIG. 5 is a flow diagram of exemplary actions according to one embodiment of the present invention;

FIG. 6 is a flow diagram of exemplary actions according to one embodiment of the present invention;

FIG. 7 is a flow diagram of exemplary actions according to one embodiment of the present invention; and

FIG. 8 is a flow diagram of exemplary actions according to one embodiment of the present invention.

These and other features and advantages of the present invention will be more readily apparent from the detailed description of the embodiments, set forth below, taken in conjunction with the accompanying drawings.

### DETAILED DESCRIPTION

The detailed description that follows is presented largely in terms of processes and symbolic representations of operations performed by conventional computers. The computer executes an appropriate operating system such as Linux, Unix, Microsoft® Windows® 95, Microsoft® Windows® 98, Microsoft® Windows® NT, Apple® MacOS®, IBM® OS/2®, and the like. The computer may advantageously be equipped with a network communication device such as a network interface card, a modem, or other network connection device suitable for connecting to one or more networks.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those of ordinary skill in the art to effectively convey teachings and discoveries to others of ordinary skill in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those of ordinary skill in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, retrieving, playing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Internet Telephony

Generally, a communication system for Internet telephony is provided to allow a caller, using an Internet telephone service, to place a telephone call to an audio communications device, such as a telephone, a PC, a Personal Data Assistant (PDA), and the like. The communication system can be used with any Internet telephone service, such as those provided by Dialpad.com™, Phonefree.com™, Net2phone™, and similar Internet telephone services. A type of Internet telephone service is disclosed and described in co-pending and commonly assigned U.S. patent application Ser. No. 09/401,898, entitled “Scaleable Communications System,” filed Sep. 24, 1999, which is incorporated herein by reference in its entirety. The term caller and user are used interchangeably herein to refer to any person, persons, or entity that uses the communication systems.

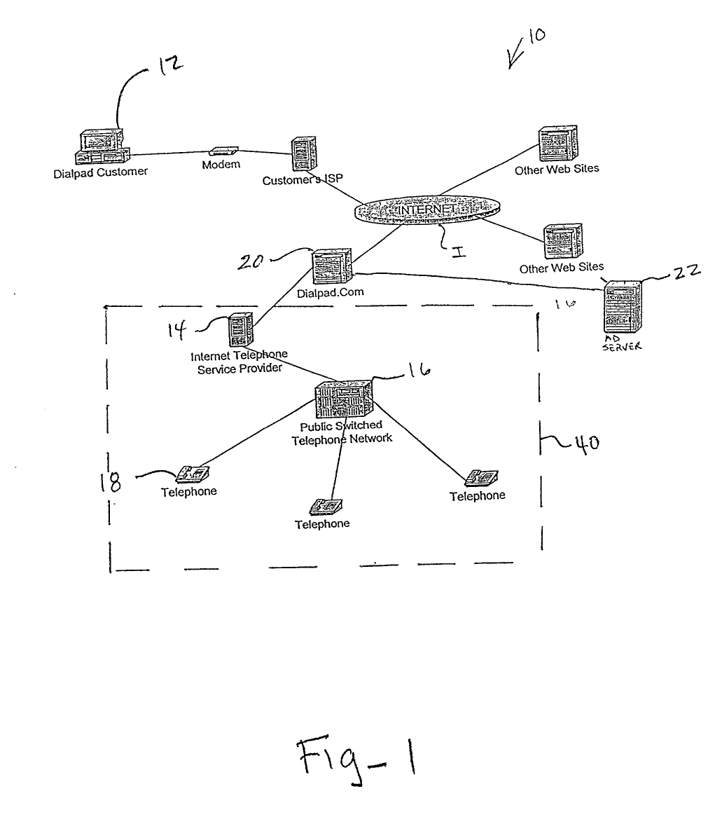

FIG. 1 is a diagram of a communications system 10 used to provide audio communications between any caller and any destination audio communication device 18, such as a PC, or wireline or wireless telephone unit. System 10 communicates with at least one internet telephone service provider (ITSP) gateway 14 using a public or private network such as the Internet I.

The at least one ITSP gateway 14 is part of an ITSP network, which is typically a private network that includes multiple ITSP gateways 14. For example, ITSP networks are provided by IDT of New Jersey and Qwest™. Each ITSP gateway 14 can have a unique address, such as an IP address. The at least one ITSP gateway 14 communicates with a public switched telephone network (PSTN) 16, which allows for communication with destination audio communication device 18. Typically, each ITSP gateway 14 uses a distinct implementation of the H.323 protocol to support communications. The at least one ITSP gateway 14, the PSTN 16 and the communication device 18 are components of communication network 40.

In one embodiment, an exemplary caller uses a conventional communication device 12, such as a telephone unit or a PC. In one example, a suitable communication device is a PC 12 (also referred to as “caller's PC 12”), which can include an input/output adapter, central processing unit (e.g., a microprocessor), and a memory. A suitable PC 12 can include, for example, an IBM PS/2 personal computer, Apple Macintosh computer, UNIX-based workstation, and a PDA, such as a Palm VII and the like available from 3com™. The PC 12 can further include a display, such as a computer monitor or other visual display device. PC 12 can also include a speaker and microphone as well as a sound card to support broadcasting of audible information and transmission of audible information, such as speech, music and the like.

As shown in FIG. 1, the PC user with access to the Internet I or a private network can use a web browser such as Microsoft Internet Explorer™ or Netscape Navigator™ to access a web page with graphical content. To specify a web site, the user enters a universal resource locator (URL) specifying both the server and the specific data (“web page”) requested. The URL may specify a hyper-text transfer protocol (HTTP) or another transfer protocol for communicating between the server and the browser. Using the Internet I, the URL is transmitted to the host server, which stores information corresponding to the URL.

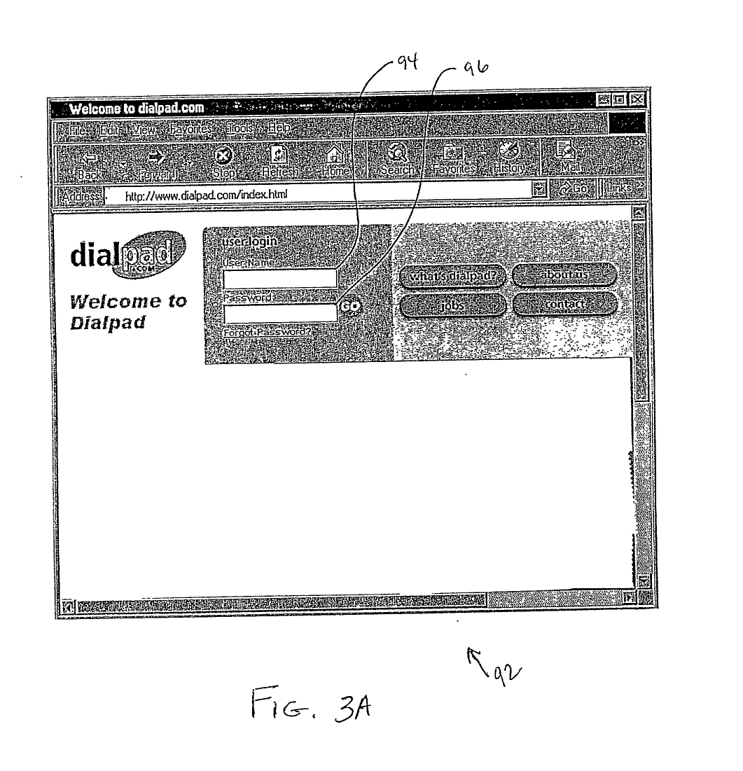

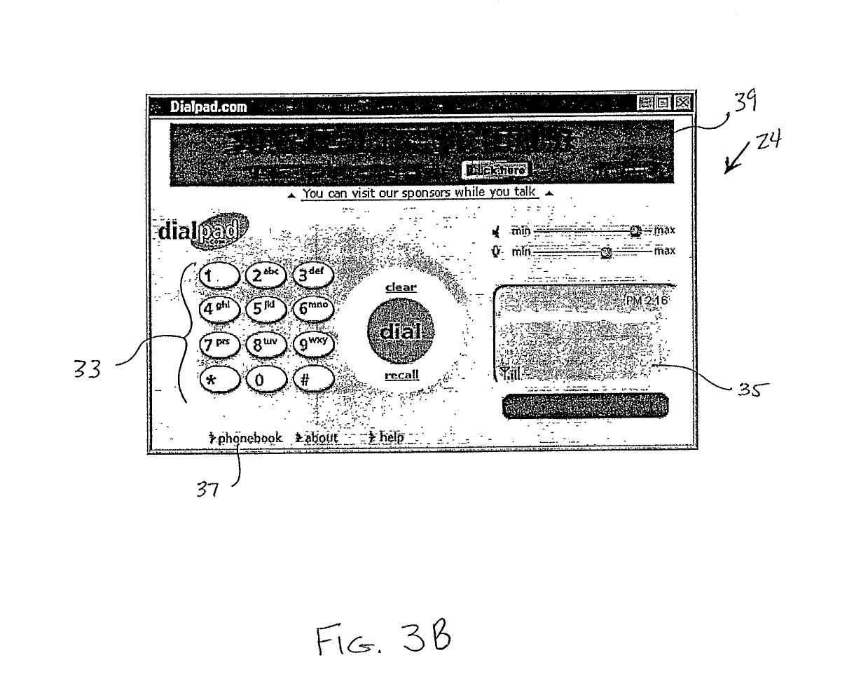

In one embodiment, the user of PC 12 accesses communication system 10 using a web site 92 stored in the network, such as the web site for Dialpad.com™ (FIG. 3A). A conventional web site server 20, such as a SPARC Server, available from SUN Microsystems™, which uses Microsoft NT 4.0, IIS, or UNIX operating system, can host web site 92 accessed by the user.

Web site server 20 supports requests from the user for features provided by the web site. The user, using a graphical web browser such as Netscape Navigator™ or Microsoft Explorer™, supplies a URL or uses a hyperlink to access the web site that includes functionality in accordance with an embodiment of the present invention. The web site is written, for example, in HTML, and includes potentially several web pages, each linked using the HTML code.

As illustrated in FIG. 3A and described in greater detail below, web site server 20 (FIG. 1) through web site 92 allows the user to “Log On” or connect to communication network 40. The user communicates at least the User ID in field 94 and Password in field 96 to web site 92. The User ID identifies a user and identifies information associated with the user that is stored by a distinct database server. The Password is used by the web server to determine whether to permit access to the user's information from the database. A suitable database server is a conventional server.

Referring again to FIG. 1, after logging-on, ITSP gateway 14 provides a voice connection between PC 12 and a remote caller, who, in this example, uses telephone 18 linked to PSTN 16. PSTN 16 provides either wired or wireless telephone service commonly known as “plain old telephone service” (POTS). ITSP gateway 14 converts the voice data from caller's PC 12 into corresponding voice signals for transmission to telephone 18 through PSTN 16. Conversely, ITSP gateway 14 converts voice signals received from telephone 18 into a form that is suitable for transmission over the Internet to caller's PC 12.

Audio Advertisement

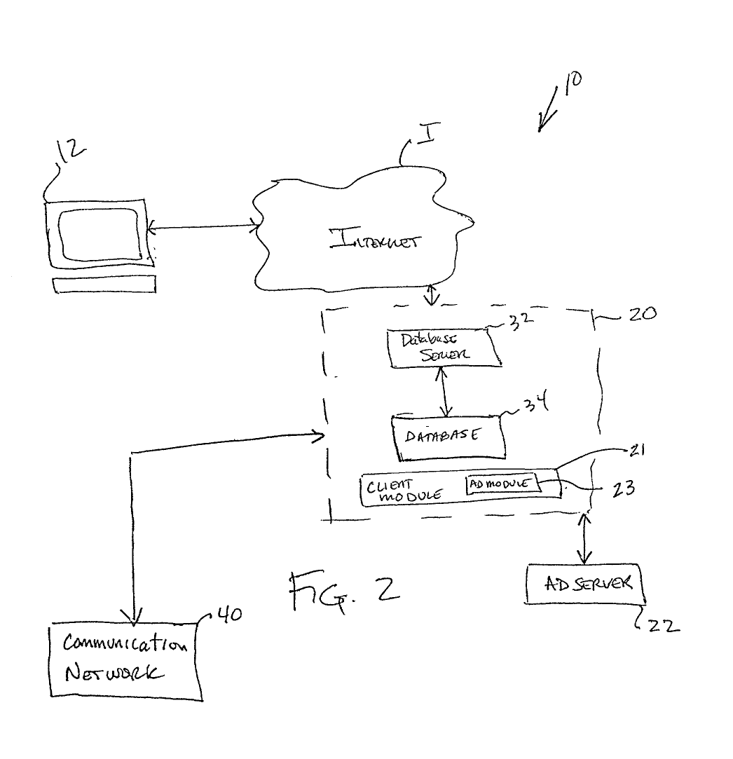

FIG. 2, according to one embodiment of the present invention, illustrates communication system 10 for internet telephony being used as a platform for providing audio ads to a user of communication system 10. The audio ads can be incorporated into an audio advertising module 23 described in detail below, which is, for example, embodied in a software program operating as a browser level application. Audio advertising module 23 can be resident on any computer in communication system 10, but is typically on a separate high performance computer, such as advertisement server 22. Audio advertising module 23 is installed in caller's PC 12 and works cooperatively with the browser application to provide the caller with dynamically updated audio ads in accordance with the present invention. The operation of the Internet telephone service is independent of audio advertising module 23, however, audio advertising module 23 can be used with the internet telephone service as described below.

As illustrated in FIG. 2, when using the Internet telephone service to place a telephone call, the caller uses PC 12 to access the Internet I or a private network. Typically, PC 12 is equipped with a web browser such as Microsoft Internet Explorer™ or Netscape Navigator™ for accessing a web page with graphical content. A client program for making the VoIP telephone call and files containing information about communication system 10 can be downloaded from web server 20. Web server 20 can be a conventional file server or any of the VoIP portals accessible over the Internet, such as those from Dialpad.com, Inc. of Santa Clara, Calif. To specify a web site, the caller enters a URL specifying both the web server and the specific data (“web page”) requested. The URL may specify HTTP or another transfer protocol for communicating between the web server and the browser. The browser interprets the web page document and prepares the host environment for the document. The browser renders the web page on the caller's computer display. The caller can access a web page applet or graphical login interface, such as shown in FIG. 3A, which allows the caller to login to the internet telephone service. Once the caller communicates at least a Password and User ID via the user interface 94 and 96 to web server 20, the web server queries database server 32 with the login information. Database server 32 uses the Password and User ID to query Database 34 to determine whether to permit access to the caller's information from Database 34.

Once access has been permitted, web site server 20 uploads a client module 21 to PC 12, which may include a variety of program logic. Client module 21 is executed by the caller and supports any communications to and from the caller. In this embodiment, code segments provided in tables, listed in Appendix A, an integral part of this disclosure, entitled “Java files”, “Resource Files”, “Microsoft COM Wrapper Class (Internet Explorer only)”, “Microsoft COM (Common Object Model) related files for Internet Explorer”, “Netscape Plugin related files for Netscape Communicator”, “C++ Compiler(Microsoft Visual C++ 6.0) related files”, “C++/Header Files”, and “External Dependencies” are uploaded to a caller.

In one embodiment, client module 21 can include an audio advertising module 23, described below, in accordance with the present invention. In this implementation, client module 21 is downloaded to PC 12, and can be installed by registering client module 21 with the Microsoft Windows® operating system using, for example, the “REGSVR32.exe” file or similar file. The registry modifications, which occur during installation of client module 21, are well known and understood by one of ordinary skill in the art. Once the package of executable files have been loaded and installed on to the caller's PC 12, client module 21 is no longer downloaded when a caller subsequently initiates a log-on to the web site. However, client module 21 existing on the caller's PC can be compared upon log-in to be updated automatically, if necessary.

Again referring to FIG. 2, the download and installation of client module 21 allows internet telephone service caller graphical interface/applet 24 (FIG. 3B) to be launched 36 automatically, or by the caller, such that the caller can connect to communication network 40.

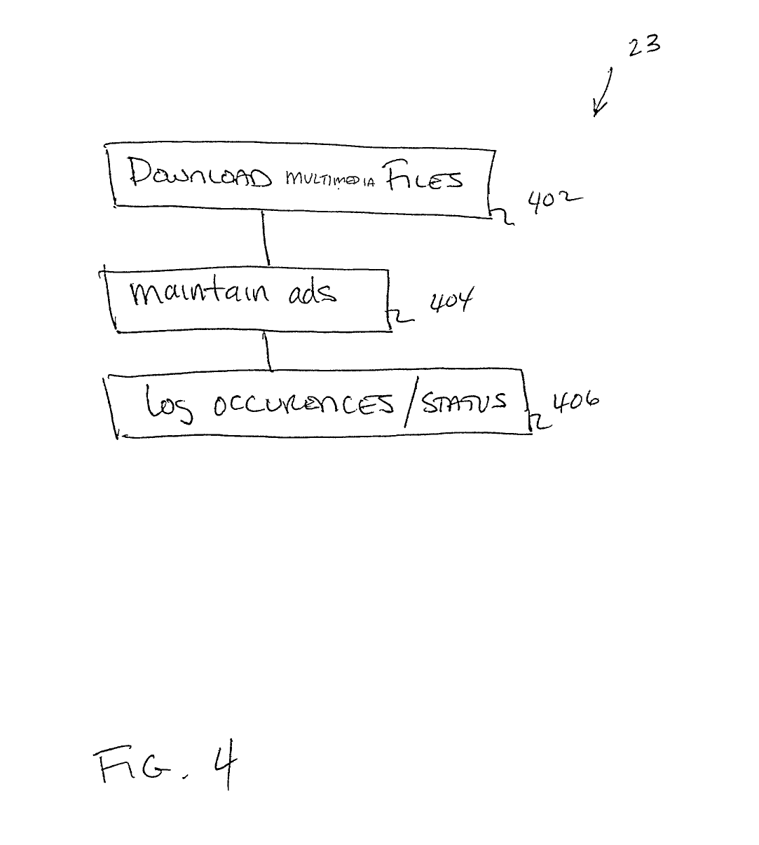

FIG. 4 is a diagram illustrating an embodiment of the general functioning of audio advertising module 23 to implement the processes of the present invention. In action 402, audio advertising module 23 can include logic that directs the automatic downloading of a plurality of multimedia files to the host PC 12. For example, in one implementation, multimedia data files (e.g., voice, audio, video, and/or still images) from a source server, such as ad server 22 (FIG. 2) are downloaded to PC 12. In one example, the multimedia data files are formatted in accordance with Transport Control Protocol (TCP). TCP, a connection-oriented protocol, transports data using a pre-established connection between two application programs. In general, TCP is well known by one of ordinary in the art, and TCP/IP software, commonly known as TCP/IP protocol stack, is commercially available from several vendors including Sun Microsystems.

The multimedia files are stored in memory, for example, in the Microsoft Windows® media directory, in a manner well-known by one of ordinary skill in the art. In one embodiment, the multimedia files, include a variety of audio ad files, which contain advertisements (e.g., ad jingles, service announcements, and the like). The audio files can be stored in various file formats. Generally there are two types of file formats: (1) self-describing formats, where device parameters and encoding are made explicit in a header, and (2) headerless formats, where device parameters and encoding are fixed.

The header of self-describing formats contain parameters of a sampling device and may also include other information (e.g., a human-readable description of sound, or a copyright notice etc.). Some examples of self-describing formats are provided below:

| File Extension | Variable Parameters (fixed; comments) |
|---|---|
| Au or .snd | rate, #channels, encoding, info string |
| Aif(f), AIFF | rate, #channels, sample width, lots of info |
| Aif(f), AIFC | same (extension of AIFF with compression) |
| Iff, IFF/8SVX | rate, #channels, instrument info (8 bits) |
| Mp2, .mp3 | rate, #channels, sample quality |
| .ra | rate, #channels, sample quality |
| .sf | rate, #channels, encoding, info |
| .smp | loops, cues, (16 bits/1 ch) |
| .voc | rate (8 bits/1 ch; can use silence deletion) |
| .wav, WAVE | rate, #channels, sample width, lots of info |

Headerless formats define single encoding and usually allow no variation in device parameters (except sometimes for sampling rates). The following are a few examples of Headerless formats:

| Extension | Parameters or name |
|---|---|
| .snd, .fssd | Variable rate, 1 channel, 8 bits unsigned |
| .ul | 8 k, 1 channel, 8 bit “u-law” encoding |
| .snd | Variable rate, 1 channel, 8 bits signed |

In one embodiment, a particular module is used to broadcast or play the audio ad file. The broadcast or player modules can include, for example, a Microsoft Media Player, MP3 player, or a WAVplayer. The use of these modules to play or broadcast audio files is well known and understood by those of ordinary skill in the art.

Referring again to FIG. 4, action 404 of audio advertising module 23 provides for the maintaining of the audio ads. In this action, audio advertising module 23 can include code which parses through the audio ad files that are currently in the host's media directory. Old audio files, such as those that are no longer to be played, are located and automatically deleted from the directory. New audio ad files are downloaded. The new and existing audio ad files can be grouped into audio ad sets. The audio ad sets define a sequence or frequency of audio ads to be played. For example, the sequence may include the order in which the ads are played, the combination of ads played either together or proximately in time, when an ad is played relative to a banner ad being displayed, and the like. The frequency may include, for example, the number of times an ad is played and how often relative to other ads that a particular ad is played. It should be understood that a determining factor for designing the sequence and frequency for playing the audio ads to the caller are the needs of advertisers and thus can vary.

Audio advertising module 23 also manages the locating of banner ads stored on ad server 22 or other server, the identifying a particular banner ad, the downloading of the particular banner ad from ad server 22, and the placing of the banner ad on the host's computer screen. For example, a conventional graphical banner ad can be displayed in position 39 of applet 24 (FIG. 3B). Alternatively, advertisements can be scheduled by use of a service, for example, a service available from Doubleclick of New York, N.Y. In one embodiment, the audio advertising module 23 matches an audio ad file with the particular banner advertisement being displayed on applet 24. In this embodiment, what the caller hears corresponds to what the caller may see graphically on the computer screen. Advertisements can be tailored to the user's interests from biographical data collected from the caller upon log on, which can maximize advertising revenue. By engaging the graphical banner advertisement, a user can purchase the product or service advertised.

In action 406, audio advertising module 23 can monitor and record the performance status of audio advertising module 23. For example, in order to be properly compensated by advertisers for the playing of audio ads, the sequence and frequency that each audio ad file has been played must be known. Thus, action 406 tracks the playing of audio ads and the setting of banner ads to quantify the status data. Action 406 also tracks the occurrence of each audio ad to ensure that the sequence and frequency order can be maintained during subsequent uses of communication system 10. For example, a status file can be created and updated to include time and date that an audio file has played, the number of times an audio file has played, the number of times an audio file has played in conjunction with a banner ad which corresponds to the content of the audio ad file, and time and date that an audio file is deleted or modified. The quantified status data provides information useful for ensuring that advertisers are properly invoiced for the advertising service. Like the status file, an occurrence file can be created and updated to include information regarding which audio ad has been played. The occurrence file can be compared to information regarding the sequence and frequency information, such that audio ads are played in the proper order during subsequent calls.

Communication System and Audio Advertising Module

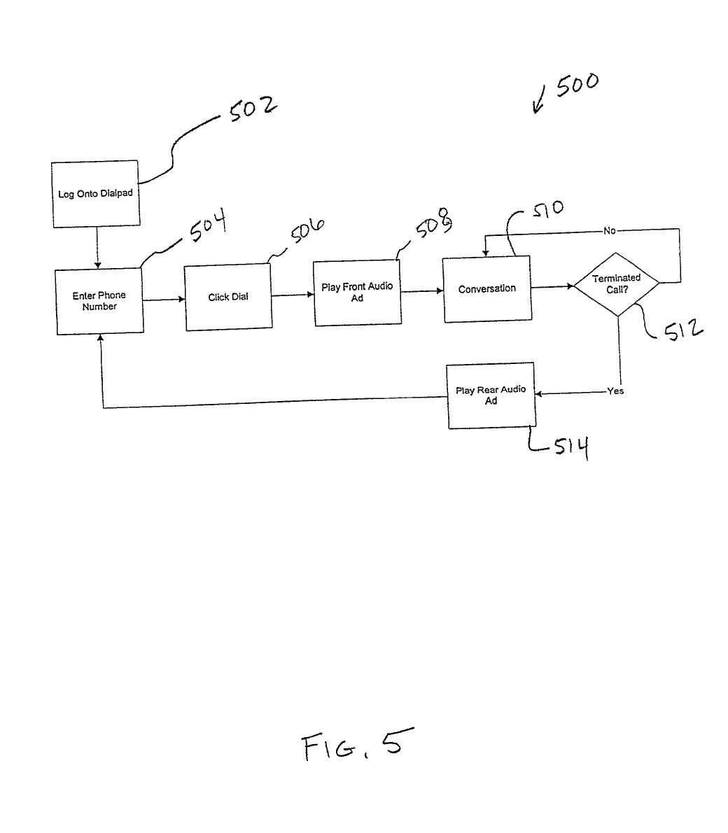

FIG. 5 is a flow diagram illustrating process 500 for establishing a communication between the caller and destination audio communications device 18 (FIG. 1) using hard coded audio ads in accordance with one embodiment of the present invention. In action 502 of process 500, the caller initiates the use of communication system 10 by following the login process discussed above. The completion of the login process and the launching of applet 24 (FIG. 3B) begins the process of dynamically loading audio advertising module 23 (FIG. 4) as provided in client module 21. In this embodiment, audio ad files are supplied with or hard coded into audio advertising module 23. For example, audio advertising module 23 may include 10 audio ad files, each including a unique advertisement.

In action 504, the user enters a destination phone number, for example, into field 33 of applet 24 (FIG. 3B). Alternatively, when caption “phone book” 37 of applet 24 is selected, a phone book is provided to the user. Selecting a phone number in such phonebook initiates a phone call to a destination audio communications device.

In action 506, the caller can select “DIAL” or similar selection to establish a communication link. In one embodiment, actions 504 and 506 cause web server 20 (FIG. 1) to select and establish a communications channel with an ITSP gateway 14 (FIG. 1). ITSP gateway 14 identifies the selected ITSP gateway to the caller. Subsequently, the caller and ITSP gateway 14 communicate directly.

In action 508, audio advertising module 23 causes a first audio to be played to the caller from the included audio ad files provided. After the hard coded ad has played, the caller's communication with the destination audio communications device 18 (action 510) commences. In action 512, audio advertising module 23 periodically checks the status of the communication session to realize if the communication session is continuing or has terminated. If the call has not terminated, no action is taken. If the caller has terminated the communication session, audio advertising module 23 causes a second hard coded audio ad to be played for the caller (action 514). The caller is then directed back to applet 24 to either place another call or to terminate the communication session.

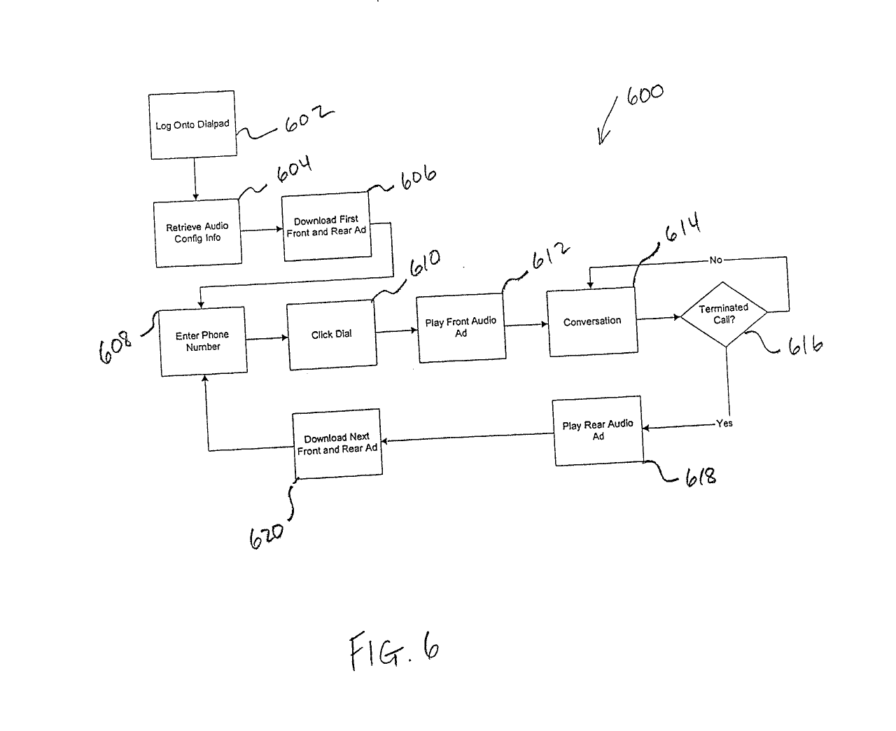

FIG. 6 is a flow diagram illustrating process 600 for establishing a communication between the caller and destination audio communications device 18 (FIG. 1) using dynamically downloaded audio ads in accordance with one embodiment of the present invention. In action 602 of process 600, the caller initiates the use of communication system 10 by following the login process discussed above. The completion of the login process and the launching of applet 24 (FIG. 3B) begins the process of dynamically loading audio advertising module 23 (FIG. 4) as provided in client module 21. In action 604, audio advertising module 23 includes program logic that allows for the retrieval of audio ad configuration files, such as a plurality of multimedia files and other audio advertisement processing information from, for example, ad server 22 or other file storage location in communication system 10.

The audio advertisement processing information, can include information regarding the identification and the location of multimedia files, including audio ad files and graphical banner ads. The processing information can also include instructions regarding the creation of audio ad sets that are targeted for certain callers. The processing information can include instructions regarding the creation of audio ad sets that define a sequence or frequency of audio ads to be played and, optionally, corresponding graphical banner ads to be displayed. For example, the processing information may instruct that a first set of audio ads be played every other time that a communication link is established by the caller. A second set of audio ads can be played all the other times that a communication link is established. The information can also instruct that no audio ads be repeated more than a specific number of times or that one or two ads from the set of audio ads be played only once regardless of how many communication links are established by the caller.

If the caller has previously used communication system 10, audio ad configuration files that may have already been placed on the caller's PC can be compared to a database of audio ads stored on, for example, ad server 22 (FIG. 1) or similar location. If the audio ad configuration files on the caller's PC are different from the audio ad configuration files available on ad server 22, the audio ad configuration files on the caller's PC are updated (e.g., old ad files are deleted and new ad files are downloaded).

In action 606, once the configuration files are loaded and/or updated, the configuration file causes a first or front audio ad file and a second or rear audio ad file to be downloaded to the caller's PC from a storage location, such as ad server 22.

In action 608, the user enters a destination phone number, for example, into field 33 of applet 24 (FIG. 3B). In action 610 the caller can select “DIAL” or similar selection to establish a communication link.

In action 612, the first or front audio ad downloaded in action 606 is played, broadcast, or similarly transmitted to the caller. After the front ad has played, the caller communicates with the destination audio communications device 18 (action 614) where a communication session may commence. In action 616, once the caller decides to terminate the communication session, the second or rear audio ad is played, broadcast, or similarly transmitted to the caller (action 618). After playing the rear audio ad, in action 620, the audio configuration file communicates with ad server 22 to download a new front ad and a new rear ad. The caller is then directed back to applet 24 to either place another call or to terminate the communication session. If the caller chooses to initiate a new call be entering a phone number (action 608) and selecting dial (action 610), the new front ad plays (action 612) for the caller. The new rear ad similarly, is played once the caller has decided to terminate a call (action 618). It should be understood that each time the caller terminates a call, a new front ad and a new rear are downloaded in anticipation of a new call.

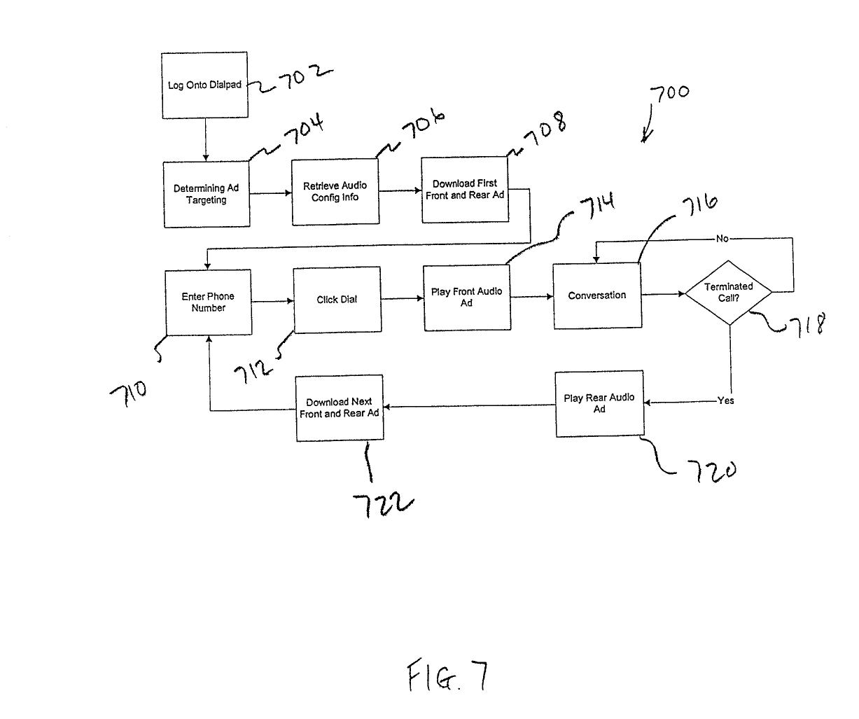

FIG. 7 is a flow diagram illustrating process 700 for establishing a communication between the caller and destination audio communications device 18 (FIG. 1) using dynamically downloaded and targeted audio ads in accordance with one embodiment of the present invention. In action 702 of process 700, the caller initiates the use of communication system 10 by following the login process discussed above. In this embodiment, the login information can be correlated with data previously collected about each caller. For example, during the initial login process, callers may be prompted to provide demographic information, such as age, gender, zip code, marital status, likes and dislikes and other similar information. This information may be used to target the caller with audio advertisements, which would appeal to the particular caller. Audio advertisements can be grouped into sets of audio advertisements that correspond to certain demographic data. Thus, in action 704, a determination is made based upon the identity of the caller (i.e. the ID name) as to which audio ads are best suited to be delivered to the caller. For example, a caller who is female and enjoys the outdoors maybe targeted with an advertisement for camping equipment or a mountain bike, while another female who does not enjoy outdoor activity may be targeted with an advertisement for a women only day spa.

The completion of the login process and selection of a targeted audio ad set, initiates the launching of applet 24 (FIG. 3B), which begins the process of dynamically loading audio advertising module 23 (FIG. 4) on the caller's PC (action 706), including audio ad configuration files, such as a plurality of multimedia files.

In action 708, once the configuration files are loaded and/or updated, a first or front audio ad file and a second or rear audio ad file are downloaded to the caller's PC. The front ad and rear ad are selected from among audio ads targeted for the caller in action 704.

In action 710, the caller enters a phone number and, in action 712, selects dial to initiate the call. Actions 710 and 712 cause web server 20 (FIG. 1) to select and establish a communications channel with an ITSP gateway 14 (FIG. 1).

In action 714, the targeted front audio ad downloaded in action 708 is played, broadcast, or similarly transmitted to the caller. After the front ad has played, the caller communicates with the destination audio communications device 18 (action 716) where a communication session may commence.

In action 718, once the caller decides to terminate the communication session, the targeted rear audio ad is played, broadcast, or similarly transmitted to the caller (action 720). After playing the rear audio ad, in action 722, the audio configuration file communicates with ad server 22 to download a new targeted front ad and a new targeted rear ad. The caller is then directed back to applet 24 to either place another call or to terminate the communication session.

If the caller chooses to initiate a new call be entering a phone number (action 710) and selecting dial (action 712), the new front ad plays (action 612) for the caller. The new rear ad similarly, is played once the caller has decided to terminate a call (action 720). It should be understood that each time the caller terminates a call, a new targeted front ad and a new targeted rear are downloaded in anticipation of a new call.

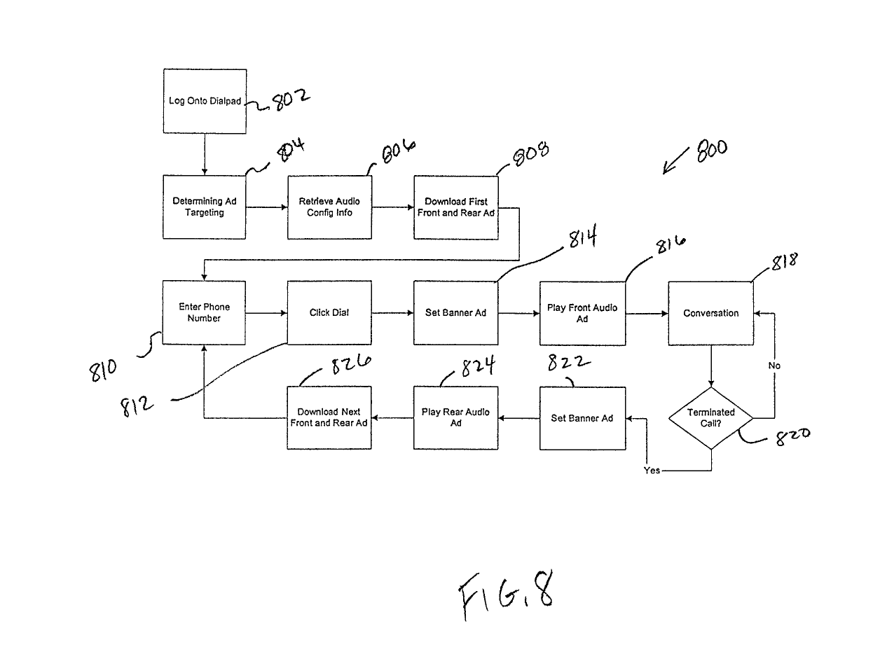

FIG. 8 is a flow diagram illustrating process 800 for establishing a communication between the caller and destination audio communications device 18 (FIG. 1) using dynamically downloaded and targeted audio ads with associated banner ads in accordance with one embodiment of the present invention. In action 802 of process 800, the caller initiates the use of communication system 10 by following the login process discussed above. In action 802, a determination is made based upon the identity of the caller (i.e. the ID name) as to which audio ads are best suited to be delivered to the caller.

The completion of the login process and selection of a targeted audio ad set, initiates the launching of applet 24, which begins the process of dynamically loading audio advertising module 23 (FIG. 4), onto the caller's PC (action 806), including audio ad configuration files, such as a plurality of multimedia files.

In action 808, once the configuration files are loaded and/or updated, a first or front audio ad file and a second or rear audio ad file are downloaded to the caller's PC. The front ad and rear ad are selected from audio ads targeted for the caller in action 804.

In action 810, the caller enters a phone number and, in action 812, selects dial to initiate the call. Actions 810 and 812 cause web server 20 (FIG. 1) to select and establish a communications channel with an ITSP gateway 14 (FIG. 1). ITSP gateway 14 identifies the selected ITSP gateway to the caller. Subsequently, the caller and ITSP gateway 14 communicate directly.

In action 814, audio advertising module 23 identifies a first banner ad to be downloaded from ad server 22 (FIG. 1) to be displayed on a web page. Audio advertising module 23 causes the banner ad to be placed on the host's computer display screen. For example, a conventional graphical banner ad can be displayed in position 39 of applet 24 (FIG. 3B). Alternatively, advertisements can be scheduled by use of a service, for example, a service available from Doubleclick of New York, N.Y. In one embodiment, audio advertising module 23 matches an audio advertisement with the particular banner advertisement being displayed on applet 24.

In action 816, the targeted front audio ad downloaded in action 808 is played, broadcast, or similarly transmitted to the caller. In this embodiment, what the caller hears corresponds to what the caller may see graphically on the computer screen. Advertisements can be tailored to the user's interests from biographical data collected from the caller upon log on, which can maximize advertising revenue. By engaging the graphical banner advertisement, a user can purchase the product or service advertised. For example, the caller chooses a number from the phonebook and the communication system begins establishing the communication link to the destination device. An audio ad, for example, a jingle for investing with the on-line broker Ameritrade™ is played, such that tie caller can hear the jingle through the PC. Simultaneously, a banner ad for Ameritrade™ can be visually displayed (field 39) on the screen of the caller's PC.

After the front ad has played, the caller communicates with the destination audio communications device 18 (action 818) where a communication session may commence. In action 820, the caller can decide to terminate the communication session.

If the communication session is to be terminated, audio advertising module 23 (FIG. 4) identifies a second banner ad to be downloaded from ad server 22 (FIG. 1) to be displayed on the web page. Audio advertising module 23 causes the banner ad to be placed on the host's computer display screen. In action 824, the targeted rear audio ad is played, broadcast, or similarly transmitted to the caller. For example, a jingle for buying flowers is played, such that the caller can hear the jingle through the PC. Simultaneously, a banner ad for 1-800-FLOWERS™ can be visually displayed on the screen of the caller's PC.

After playing the rear audio ad, in action 826, audio advertising module 23 communicates with ad server 22 to download a new targeted front ad and a new targeted rear ad. The caller is then directed back to applet 24 to either place another call or to terminate the communication session.

Appendix B contains an example, with no intent to limit the invention thereby, of a listing of software code outlining an exemplary method for providing dynamically updated audio data in accordance with the present invention. Appendix B has been previously incorporated by reference as an integral part of the application.

While particular embodiments of the present invention have been shown and described, it will be obvious to those having ordinary skill in the art that changes and modifications can be made without departing from this invention in its broader aspects. This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

[image]

[image]

[image]

[image]

[image]

[image]

[image]

[image]

[image]

What is claimed is:

1. A method of providing dynamically updated audio data comprising:
downloading at least one multimedia file including audio advertisement data;
downloading configuration instructions; and
broadcasting said audio advertisement data in accordance with said configuration instructions.

2. The method of claim 1, further comprising:
downloading additional audio advertisement data; and
broadcasting said additional audio data in accordance with said audio configuration instructions.

3. The method of claim 2, further comprising:
interrupting said downloading of said additional audio data;
establishing a communication link; and thereafter
resuming said downloading of said additional audio data.

4. A method for providing audio advertisements for users of a communication system comprising:
accessing a web site;
establishing a path for audio communications; and
receiving a first audio advertisement.

5. The method of claim 4, further comprising receiving a second audio advertisement.

6. The method of claim 4, wherein said path for audio communications comprises ITSP gateway, a PSTN and a remote receiver.

7. The method of claim 4, wherein said web site provides graphical advertisement and wherein said establishing of said path for audio communication is free to select users.

8. The method of claim 7, wherein subject matter of said first audio advertisement corresponds to advertising subject matter of said graphical advertisement.

9. The method of claim 4, further comprising providing a plurality of audio advertisements to said user wherein said providing follows a predetermined sequence.

10. A method for advertising to users of a communications system which provides communications between a caller and destination audio receiver, the method comprising:
accessing a web page using a browser;
retrieving audio advertisement processing information; and
downloading a first front audio advertisement and a first rear audio advertisement,
said front audio advertisement being playable to said caller before said caller establishes a communication, said rear audio advertisement being playable after said caller terminates said communication.

11. The method of claim 10, further comprising downloading additional audio advertisements.

12. The method of claim 10, further comprising displaying a graphical advertisement on said web page, said graphical advertisement corresponding to said front audio advertisement.

13. The method of claim 10, wherein said audio advertisement processing information comprises audio advertisement identifiers, audio advertisement locations, graphical advertisement identifiers, and graphical advertisement locations.

14. The method of claim 10, wherein said audio advertisement processing information comprises information defining a sequence and/or a frequency of audio advertisements to be played.

15. The method of claim 10, further comprising:
establishing a communication link; and
playing said front audio advertisement.

16. The method of claim 15, further comprising:
terminating said communication link; and
playing said rear audio advertisement.

17. The method of claim 16, wherein said playing of said front and said rear audio advertisement includes setting a graphical banner advertisement on said web page having a graphical content which corresponds to an audio content of each of said audio advertisements.

18. The method of claim 10, further comprising:
establishing a first communication link;
playing said front audio advertisement;
terminating said first communication link;
playing said rear audio advertisement;
downloading a second front audio advertisements;
downloading a second rear audio advertisement;
establishing a second communication link;
playing said second front audio advertisement;
terminating said second communication link; and
playing said second rear audio advertisement.

19. The method of claim 18, wherein said audio advertisement processing information includes information for selecting said first front audio advertisement, said first rear audio advertisement, said second front audio advertisement and said second rear audio advertisement.

20. The method of claim 18, wherein said playing of each of said front, and said rear audio advertisements includes setting a graphical banner advertisement on said web page having a graphical content which corresponds to an audio content of each of said front and rear audio advertisements.

21. A system for dynamically providing advertising to users of a telephony service, the system comprising:
a communications module for providing communications between a caller and destination audio receiver; and
an audio advertisement module providing audio advertisement processing information, a first audio advertisement and a second audio advertisement,
said first audio advertisement and said second audio advertisement being playable to said caller according to said processing information.

22. The system of claim 21, wherein said first audio advertisement is playable before said caller establishes a communication, and said second audio advertisement is playable after said caller terminates said communication.

23. The system of claim 21, wherein said audio advertisement module provides three or more audio advertisements.

24. The system of claim 21, wherein said audio advertisement module provides a graphical advertisement on said web page, said graphical advertisement corresponding to said first audio advertisement.

25. The system of claim 21, wherein said audio advertisement processing information comprises audio advertisement identifiers, audio advertisement locations, graphical advertisement identifiers, and graphical advertisement locations.

26. The system of claim 21, wherein said audio advertisement processing information comprises information defining a sequence and/or a frequency of audio advertisements to be played.

27. The system of claim 21, wherein said audio advertisement module causes a graphical banner advertisement to be set on said web page having a graphical content which corresponds to an audio content of each of said first and said second audio advertisements.
